(19) United States
(12) Patent Application Publication
(10) Pub. No.: US 2016/0187744 A1
(43) Pub. Date: Jun. 30, 2016

(54) METHOD AND DEVICE FOR ENHANCING RESPONSE TIME OF POSITIVE-NEGATIVE MIXED LIQUID CRYSTALS

(71) Applicant: Shenzhen China Star Optoelectronics Technology Co. Ltd., Shenzhen, Guangdong (CN)

(72) Inventor: Chang XIE, Shenzhen, Guangdong (CN)

(73) Assignee: Shenzhen China Star Optoelectronics Technology Co. Ltd., Shenzhen, Guangdong (CN)

(21) Appl. No.: 14/433,635

(22) PCT Filed: Dec. 30, 2014
(86) PCT No.: PCT/CN2014/095573

§ 371 Date: Apr. 3, 2015

(30) Foreign Application Priority Data
Dec. 24, 2014 (CN) 2014108174425

(51) Int. Cl. G02F 1/1343

(52) U.S. Cl. CPC G02F 1/134336

(57) ABSTRACT

A method and device for enhancing a response time of positive-negative mixed liquid crystals. The method includes: configuring at least one horizontal electrode, at least one vertical electrode and the positive-negative mixed liquid crystals of the liquid crystal panel; electrifying the horizontal electrode, and the positive-negative mixed liquid crystals are in a rising time period; electrifying the vertical electrode, and the positive-negative mixed liquid crystals are in a falling time period; the response time of the positive-negative mixed liquid crystals is a sum of the rising time period and the falling time period. In this way, the falling time period of the positive-negative mixed liquid crystals may be enhanced, and thus the response time may be enhanced.

### BACKGROUND OF THE INVENTION

1. Field of the Invention

The present disclosure relates to liquid crystal display technology, and more particularly to a method and device for enhancing response time of positive-negative mixed liquid crystals.

2. Discussion of the Related Art

The response time of liquid crystals relates to the time delay during which each of the sub-pixel cells has displayed a previous frame and a current frame and then back to the previous frame, and such time delay is mainly caused by rotated liquid crystal molecules. Currently, a new positive-negative mixed liquid crystals has been developed, which includes a higher vertical dielectric coefficient than normal liquid crystals. The positive-negative mixed liquid crystals may be rotated along a horizontal direction, which results in a higher transmission rate of the liquid crystal panel.

As the monomer of the positive-negative mixed liquid crystals has a larger viscosity such that the response time of such liquid crystal is longer. As such, Caton phenomenon may happen when the displayed images have been switched. In addition, black screen phenomenon may also happen, which may affect user experience.

### SUMMARY

According to the present disclosure, the method and device for enhancing the response time of the positive-negative mixed liquid crystals are disclosed, which ensure a higher transmission rate and a shorter response time.

In one aspect, a method for enhancing a response time of positive-negative mixed liquid crystals includes: configuring at least one horizontal electrode, at least one vertical electrode and the positive-negative mixed liquid crystals of the liquid crystal panel; electrifying the horizontal electrode, and the positive-negative mixed liquid crystals are in a rising time period; electrifying the vertical electrode, and the positive-negative mixed liquid crystals are in a falling time period; and the positive-negative mixed liquid crystals are made by adding a portion of negative liquid crystal monomers into positive liquid crystals, the response time of the positive-negative mixed liquid crystals is a sum of the rising time period and the falling time period, and during the response time, the liquid crystal panel transits from a dark state to a bright state and then back to the dark state.

Wherein the configuring step further includes: arranging the horizontal electrode in a different layer at one side of the vertical electrodes, the horizontal electrodes are interleaved with the vertical electrodes, and the positive-negative mixed liquid crystals are arranged between the electrodes arranged in different layers.

Wherein an extending direction of the horizontal electrode is vertical to the extending direction of the vertical electrode, the horizontal electrode comprises at least one first common electrode and at least one first pixel electrode parallel to the first common electrode, and the vertical electrode comprises at least one second common electrode and at least one second pixel electrode parallel to the second common electrode.

Wherein when the horizontal electrode is electrified, the first common electrode and the first pixel electrode are electrified, and when the vertical electrode is electrified, the second common electrode and the second pixel electrode are electrified.

In another aspect, a method for enhancing a response time of positive-negative mixed liquid crystals includes: configuring at least one horizontal electrode, at least one vertical electrode and the positive-negative mixed liquid crystals of the liquid crystal panel; electrifying the horizontal electrode, and the positive-negative mixed liquid crystals are in a rising time period; electrifying the vertical electrode, and the positive-negative mixed liquid crystals are in a falling time period; and the positive-negative mixed liquid crystals is made by adding a portion of negative liquid crystal monomers into positive liquid crystals, and the response time of the positive-negative mixed liquid crystals is a sum of the rising time period and the falling time period.

Wherein the configuring step includes: arranging the horizontal electrode in a different layer at one side of the vertical electrodes, the horizontal electrodes are interleaved with the vertical electrodes, and the positive-negative mixed liquid crystals are arranged between the electrodes arranged in different layers.

Wherein an extending direction of the horizontal electrode is vertical to the extending direction of the vertical electrode, the horizontal electrode comprises at least one first common electrode and at least one first pixel electrode parallel to the first common electrode, the vertical electrode comprises at least one second common electrode and at least one second pixel electrode parallel to the second common electrode.

Wherein when the horizontal electrode is electrified, the first common electrode and the first pixel electrode are electrified, and when the vertical electrode is electrified, the second common electrode and the second pixel electrode are electrified.

Wherein the positive-negative mixed liquid crystals is made by adding a portion of negative liquid crystal monomer into the positive liquid crystals.

Wherein during the response time, the liquid crystal panel transits from a dark state to a bright state and then back to the dark state.

In another aspect, a device for enhancing a response time of positive-negative mixed liquid crystals includes: electrodes and positive-negative mixed liquid crystals; and the electrode comprises horizontal electrodes and vertical electrodes, the positive-negative mixed liquid crystals are arranged between the horizontal electrode and the vertical electrode, the response time of the positive-negative mixed liquid crystals is a sum of a rising time period and a falling time period of the positive-negative mixed liquid crystals, the horizontal electrode is electrified during the rising time period and the vertical horizontal is electrified during the falling time period.

Wherein the horizontal electrodes are arranged in a different layer at one side of the vertical electrodes, and the horizontal electrodes are interleaved with the vertical electrodes.

Wherein an extending direction of the horizontal electrode is vertical to the extending direction of the vertical electrode, the horizontal electrode comprises at least one first common electrode and at least one first pixel electrode parallel to the first common electrode, the vertical electrode comprises at least one second common electrode and at least one second pixel electrode parallel to the second common electrode.

Wherein when the horizontal electrode is electrified, the first common electrode and the first pixel electrode are electrified, and when the vertical electrode is electrified, the second common electrode and the second pixel electrode are electrified.

In view of the above, during the falling time period, the vertical electrodes of the liquid crystal panel is electrified. The liquid crystal molecules rotate to the initial alignment location quickly due to the electrical field formed by the vertical electrode, instead of the anchoring forces of the liquid crystal molecules themselves. In this way, the response time of the liquid crystals is reduced so as to enhance the response time of the positive-negative mixed liquid crystals.

### BRIEF DESCRIPTION OF THE DRAWINGS

FIG. 1 is a flowchart showing the method for enhancing the response time of the positive-negative mixed liquid crystals in accordance with a first embodiment.

FIG. 2 is a flowchart showing the method for enhancing the response time of the positive-negative mixed liquid crystals in accordance with a second embodiment.

FIG. 3 is a schematic view of the device for enhancing the response time of the positive-negative mixed liquid crystals in accordance with a first embodiment.

FIG. 4 is a top view of the device for enhancing the response time of the positive-negative mixed liquid crystals in accordance with a first embodiment.

FIG. 5 is a schematic view of the device for enhancing the response time of the positive-negative mixed liquid crystals in accordance with one embodiment.

FIG. 6 is a schematic view of the device for enhancing the response time of the positive-negative mixed liquid crystals in accordance with a first embodiment, wherein the first cover glass 3011 includes a plurality of electrodes arranged in different layers.

### DETAILED DESCRIPTION OF THE EMBODIMENTS

Embodiments of the invention will now be described more fully hereinafter with reference to the accompanying drawings, in which embodiments of the invention are shown.

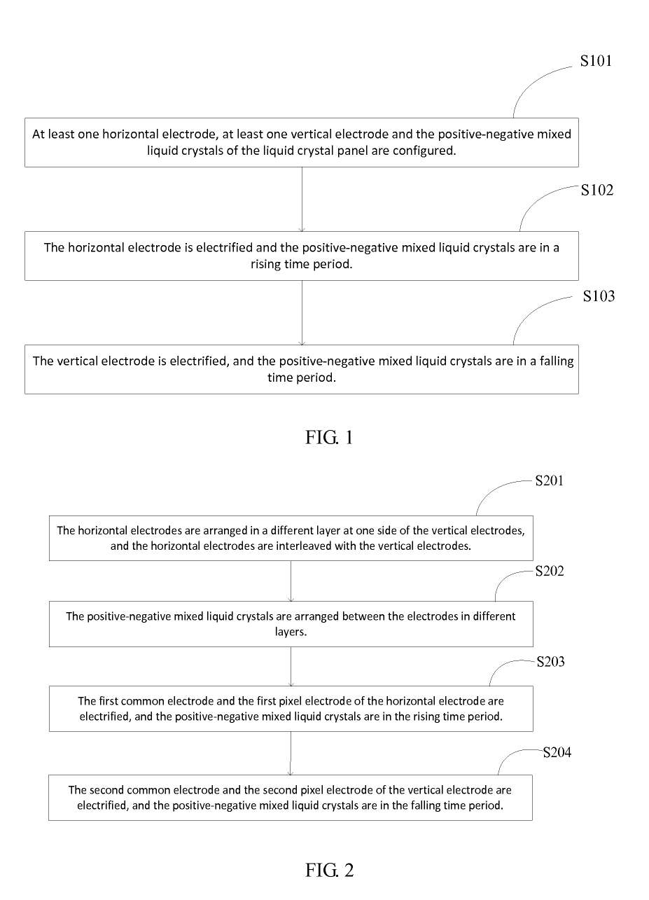

FIG. 1 is a flowchart showing the method for enhancing the response time of the positive-negative mixed liquid crystals (“the method”) in accordance with a first embodiment. The method includes the following steps.

In step S101, at least one horizontal electrode, at least one vertical electrode and the positive-negative mixed liquid crystals of the liquid crystal panel are configured.

The liquid crystal material is the basic components of the liquid crystal panels. The alignment of the internal molecules of the liquid crystal is changed by applying a voltage so as to mask or unmask light beams. The positive-negative mixed liquid crystals is formed by adding a portion of negative liquid crystal monomer into the positive liquid crystals. As the vertical dielectric coefficient of the negative liquid crystal monomer is larger, the vertical dielectric coefficient of the mixed liquid crystals is increased. As such, the tilted angle between the liquid crystals and the liquid crystal panel may decrease, which results in that the liquid crystal molecules may horizontally rotate along a plane parallel to the liquid crystal panel. At this moment, the liquid crystal panel has a higher transmission rate and a better display performance. It can be found by experiments that the positive-negative mixed liquid crystals may enhance the transmission rate for a ratio between 3 and 8 percent than positive liquid crystals. In addition, the transmission rate for the conventional liquid crystal panel is around 10 percent.

Within the liquid crystal display field, the response time relates to the process in which each sub-pixel cells of the liquid crystal panel transits from a dark state to a bright state and then back to the dark state, which is mainly due to the rotation of the liquid crystal molecules. As a portion of negative liquid crystal monomers exist in the positive-negative mixed liquid crystals, the larger viscosity of the liquid crystal monomers may retard the rotation of the liquid crystal molecules. With respect to conventional technology, the electrical field is formed in a proximity of the liquid crystals. The liquid crystal molecules may rotate due to the forces of the electrical field. After the electrical field is removed, the liquid crystal molecules back to the initial alignment direction, which may be retarded due to the larger viscosity. Thus, the response time of the positive-negative mixed liquid crystals is increased.

In the embodiment, the horizontal electrode and the vertical electrode are arranged on the liquid crystal panel. After the liquid crystal panel is electrified, the electrical fields along a vertical direction and along a horizontal direction are respectively formed between plates of the horizontal electrode and the vertical electrode. As the liquid crystal molecules have polarity, the liquid crystal molecules may rotate due to the electrical field.

In step S102, the horizontal electrode is electrified and the positive-negative mixed liquid crystals are in a rising time period.

First, an alignment module of the liquid crystal panel may determines an initial direction of the positive-negative mixed liquid crystals. The alignment module is configured for setting the pretilt angle of the liquid crystal molecules. The alignment module may be an alignment layer or an alignment slot. After the horizontal electrode is electrified, the positive-negative mixed liquid crystals may be polarized due to the electrical filed and may rotate. The effect of the polarization makes one end of the liquid crystal molecule carry positive electricity. In addition, the end of the liquid crystal molecules carrying the positive electricity is drew into the negative direction of the electrical field due to the Coulomb forces. On the other hand, one end of the molecules carrying negative charges may be drew to the positive direction of the electrical field, which cause the liquid crystal molecules rotate. At this moment, the period during which the liquid crystal molecules have been rotated relates to a rising time period of the liquid crystal response time. The positive-negative mixed liquid crystals rotate in response to the electrical filed formed by the horizontal electrode.

In step S103, the vertical electrode is electrified, and the positive-negative mixed liquid crystals are in a falling time period.

As the liquid crystal molecules are ellipse-shaped, a line connecting two vertexes of the ellipse is referred to as a long axis of the liquid crystal molecule. The liquid crystal molecules has special alignment in different direction. For instance, the liquid crystal molecules may be aligned along the long axis or along a direction vertical to the long axis. As such, the physical constants, i.e., reflective rate, capacitive rate, magnetic rate, and electrical conductive rate. That is, the liquid crystals include anisotropy. After the liquid crystal molecules have been rotated due to the electrical field formed by the horizontal electrode, the electrical field has no further impact to the liquid crystal molecules. At this moment, if the electrical field formed by the horizontal electrode is removed, the liquid crystal molecules may rotate to the location during initial alignment due to anchoring forces. According to the present disclosure, the positive-negative mixed liquid crystals has a larger adhesive coefficient than normal liquid crystals, which decreases the above-mentioned anchoring forces and extends the response time of the liquid crystals. Thus, the vertical electrode is electrified, the electrical field vertical to the one formed by the horizontal electrode is formed. The positive and negative charges within the liquid crystal molecules continue rotating or rotating until the long axis of the liquid crystal molecules is parallel to the direction of the electrical field, and then the liquid crystal molecules stop rotating. The forces drive the liquid crystal molecules back to the original location are not the anchoring forces during the initial alignment. In other words, the liquid crystal molecules are driven to be the original location due to the vertical electrical field, which also decreases the response time of the liquid crystals.

In view of the above, during the falling time period, the vertical electrode of the liquid crystal panel is electrified. The liquid crystal molecules rotate to the initial alignment location quickly due to the electrical field formed by the vertical electrode, instead of the anchoring forces of the liquid crystal molecules themselves. In this way, the response time of the liquid crystals is reduced so as to enhance the response time of the positive-negative mixed liquid crystals.

FIG. 2 is a flowchart showing the method for enhancing the response time of the positive-negative mixed liquid crystals in accordance with a second embodiment. The method includes the following steps.

In step S201, the horizontal electrodes are arranged in a different layer at one side of the vertical electrodes, and the horizontal electrodes are interleaved with the vertical electrodes.

The horizontal electrodes and the vertical electrodes are arranged in different layer in sequence and are interleaved with each other. The sequence of the layers for arranging the horizontal electrodes and the vertical electrodes may be switched. The two electrodes are independently controlled by themselves. The horizontal electrode is arranged to be vertical to the arranged vertical electrode.

In step S202, the positive-negative mixed liquid crystals are arranged between the electrodes in different layers.

The positive-negative mixed liquid crystals are arranged between the horizontal electrode and the vertical electrode. The distance between the mixed liquid crystal layer and the horizontal/vertical electrode is the same. Thus, the electrical field formed by the two electrodes may have the same impact to the mixed liquid crystals. First, the alignment module may configure an initial angle of the liquid crystal molecules. As the liquid crystal molecules are ellipse-shaped, the initial angle may be the angle between the long axis of the liquid crystal molecules and the electrical field formed by the horizontal electrode.

In step S203, the first common electrode and the first pixel electrode of the horizontal electrode are electrified, and the positive-negative mixed liquid crystals are in the rising time period.

The horizontal electrode may include the first common electrode and the first pixel electrode arranged in parallel having similar shapes. The electrical field is formed after the first common electrode and the first pixel electrode are electrified. The direction of the electrical field is from one plate of the first common electrode and the first pixel electrode toward one plate of another electrode. The forces of the electrical field have been applied to the positive-negative mixed liquid crystals so as to polarize the liquid crystal molecules. One end of the liquid crystal molecules carrying the positive charges is drew to the negative direction of the electrical field, and one end of the liquid crystal molecules carrying the negative charges is drew to the positive direction of the electrical field. The generated Coulomb forces drive the liquid crystal molecules to rotate until the direction of the long axis of the liquid crystal molecules is parallel to the direction of the electrical field, and then the liquid crystal molecules stops rotating. At this moment, the rotating process of the liquid crystal molecules relates to the rising time period of the liquid crystal response time.

In step S204, the second common electrode and the second pixel electrode of the vertical electrode are electrified, and the positive-negative mixed liquid crystals are in the falling time period.

Similar to the horizontal electrode, the vertical electrode includes a second common electrode and a second pixel electrode. The arrangement of the second common electrode and the second pixel electrode are the same with that of the first common electrode and the first pixel electrode of the horizontal electrode. The second common electrode and the second pixel electrode are vertical to the horizontal electrode. In step S203, the electrical field formed by the horizontal electrode drives the liquid crystal molecules to rotate until the long axis of the liquid crystal molecules are vertical to the horizontal electrode, and then the liquid crystal molecules stops rotating. After the electrical field formed by the horizontal electrode is removed, a new electrical field is formed by electrifying the second common electrode and the second pixel electrode. The direction of the electrical field is from one plate of the second common electrode and the second pixel electrode toward one plate of another electrode. The forces of the newly formed electrical field may be applied to the polarized liquid crystal molecules. One end carrying the positive charges is drew to the negative direction of the electrical field, and one end of the liquid crystal molecules carrying the negative charges is drew to the positive direction of the electrical field. The generated Coulomb forces drive the liquid crystal molecules to rotate, and the direction of the rotation is relative to the direction of the electrical field formed by the vertical electrode. In an example, the liquid crystal molecules may rotate along a rotating direction when the electrical field is formed by the horizontal electrode. In another example, the liquid crystal molecules may rotate along a direction, which is opposite to the rotation direction when the electrical field is formed by the horizontal electrode, until the long axis of the liquid crystal molecules is parallel to the horizontal electrode, and then the liquid crystal molecules stops rotation. The rotating process is the falling time period of the liquid crystal response time.

In view of the above, the vertical electrodes are arranged along a direction vertical to the horizontal electrode. The liquid crystal molecules are driven to rotate due to the forces of the electrical field so as to enhance the liquid crystal response time. At the same time, the horizontal transition technology is adopted, which results in a shorter response time and a more stable one.

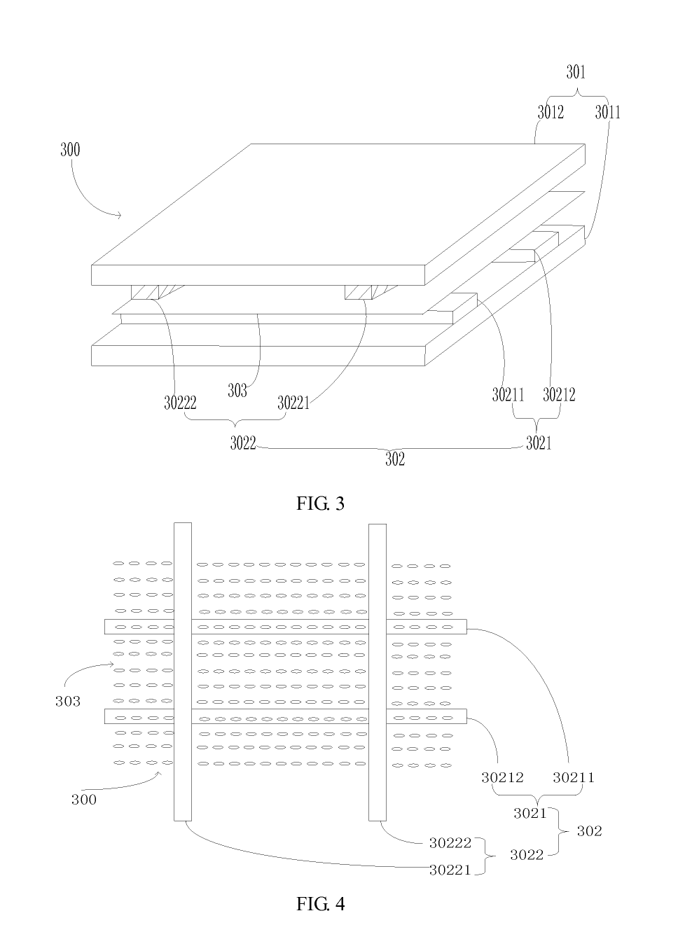

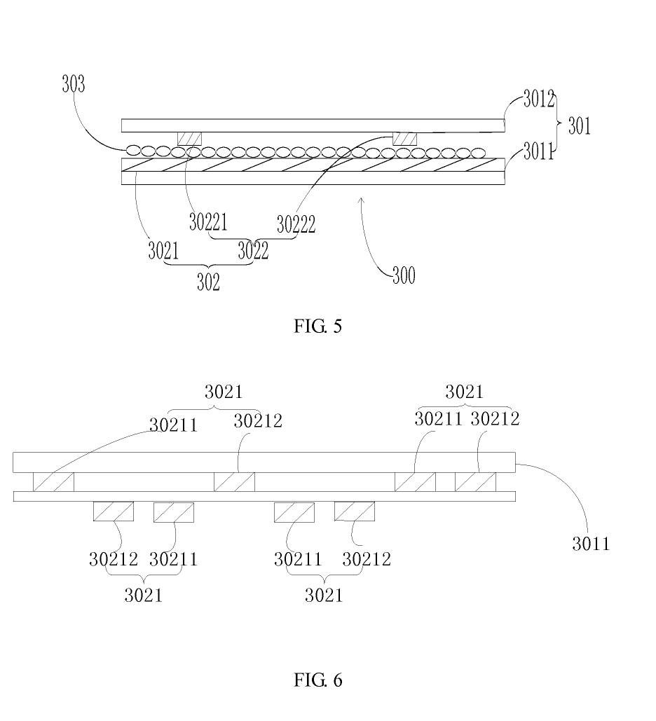

FIG. 3 is a schematic view of the device for enhancing the response time of the positive-negative mixed liquid crystals (“device) in accordance with a first embodiment. FIG. 4 is a top view of the device for enhancing the response time of the positive-negative mixed liquid crystals in accordance with a first embodiment. FIG. 5 is a schematic view of the device for enhancing the response time of the positive-negative mixed liquid crystals in accordance with one embodiment. FIG. 6 is a schematic view of the device for enhancing the response time of the positive-negative mixed liquid crystals in accordance with a first embodiment, wherein the first cover glass 3011 includes a plurality of electrodes arranged in different layers.

The device 300 includes a cover glass 301, an electrode 302, and a positive-negative mixed liquid crystal layer 303. The cover glass 301 includes a first cover glass 3011 and a second cover glass 3012. The first cover glass 3011 and the second cover glass 3012 are arranged in parallel, and are spaced apart from each other in a small distance. The first cover glass 3011 and the second cover glass 3012 may be made by aluminosilicate glass with high concentration of aluminum and alkali or soda-lime-silica glass. The electrode 302 may be made by ITO electrode covering a surface of the cover glass 301. The positive-negative mixed liquid crystal layer 303 is arranged between the first cover glass 3011 and the second cover glass 3012. The positive-negative mixed liquid crystals relates to adding a portion of negative liquid crystal monomers into the positive liquid crystals. The dipole moments of the positive liquid crystal molecules is parallel to the long axis of the molecules. This kind of liquid crystals have a quick response time and a low driving voltage, but the light efficiency is low. In addition, the molecules are tiltedly arranged. The dipole moments of the negative liquid crystal molecules is vertical to the long axis of the molecules. This kind of liquid crystals have a slow response time and a high driving voltage, but the light efficiency is high. In addition, the molecules are arranged horizontally. The negative liquid crystal increases the vertical dielectric coefficient of the positive-negative mixed liquid crystal layer 303, but increases the viscosity of the positive-negative mixed liquid crystals. In addition, at least one alignment layer (not shown) is arranged between the liquid crystal layer and the electrode for guiding the alignment of the liquid crystal molecules. In one embodiment, one alignment layer is respectively arranged below and beyond the positive-negative mixed liquid crystal layer 303. Before the electrical field is formed, the alignment layer may configure an initial angle of the liquid crystal molecules.

The electrode 302 includes a horizontal electrode 3021 and a vertical electrode 3022. The horizontal electrode 3021 and the vertical electrode 3022 may respectively adhere to the first cover glass 3011 and the horizontal electrode 3021 in a variety of ways. The horizontal electrode 3021 includes at least one first common electrode 30211 and at least one first pixel electrode 30212 interleaved with the first common electrode 30211. The first common electrode 30211 is parallel to the first pixel electrode 30212. The vertical electrode 3022 includes at least one second common electrode 30221 and at least one second pixel electrode 30222 interleaved with the second common electrode 30221. The second common electrode 30221 is parallel to the second pixel electrode 30222. The first common electrode 30211, the first pixel electrode 30212, the second common electrode 30221, and the second pixel electrode 30222 may be respectively arranged on an internal surface of the first cover glass 3011 facing toward the internal surface of the second cover glass 3012. The extending direction of the first common electrode 30211 and the first pixel electrode 30212 is vertical to the extending direction of the second common electrode 30221 and the second pixel electrode 30222.

An independent power supply (not shown) has been connected to the first common electrode 30211, the first pixel electrode 30212, the second common electrode 30221, and the second pixel electrode 30222 such that the electrical field is formed between the first cover glass 3011, the first common electrode 30211, and the first pixel electrode 30212 and the electrical field is formed between the second cover glass 3012, the second common electrode 30221 and the second pixel electrode 30222. The direction of the electrical field is from one electrode of one cover glass toward another electrode of the cover glass.

In the embodiment, the direction of the electrical field formed by the electrode on the cover glass is from the common electrode toward the pixel electrode. The forces of the electrical field may be applied toward the positive-negative mixed liquid crystal layer 303 between the two cover glasses.

During operations, the power supply (not shown) forming the electrical field between the first common electrode 30211 and the first pixel electrode 30212 is turn on. The direction of the electrical field is from the first common electrode 30211 toward the first pixel electrode 30212. At this moment, the liquid crystal molecules of the positive-negative mixed liquid crystal layer 303 are polarized due to the electrical field. The polarized liquid crystal molecules may rotate due to the electrical field until the long axis of the liquid crystal molecules is parallel to the direction of the electrical field. At this moment, the charges within the liquid crystal molecules may be balanced due to the Coulomb forces from the electrical field. The rotating process of the liquid crystal molecules relates to the rising time period of the liquid crystal response time. Afterward, the power supply forming the electrical field between the first common electrode 30211 and the first pixel electrode 30212 is turn off. The power supply forming the electrical field between the second common electrode 30221 and the second pixel electrode 30222 is turned on. The direction of the electrical field is from the second common electrode 30221 toward the second pixel electrode 30222. The direction of the newly formed electrical field is vertical to the long axis of the liquid crystal molecules. The Coulomb forces from the newly formed electrical field may apply toward the liquid crystal molecules such that the liquid crystal molecules keeps on rotating. Alternatively, the liquid crystal molecules may rotate along a reversed direction of the liquid crystal molecules when the electrical field is formed by the horizontal electrode. When the long axis of the liquid crystal molecules is parallel to the direction of the newly formed electrical field, the liquid crystal molecules stops rotating.

In the embodiment, a plurality of common electrodes and a plurality of pixel electrodes may be arranged on the same cover glass. The common electrodes and the pixel electrodes are interleaved and parallel to each other. In addition, one common electrode and one pixel electrode are configured as a set. The electrical field is formed between the common electrode and the pixel electrode within one set. Each set is controlled by independent power supply. At the same time, the electrodes for the same cover glass may be arranged in different layers. For instance, when the first cover glass 3011 only includes one first common electrode 30211 and one first pixel electrode 30212, the first common electrode 30211 may be arranged on an internal surface of the first cover glass 3011. An insulation layer is arranged on the first common electrode 30211. The first pixel electrode 30212 is arranged on the surface of the insulation layer opposite to the surface having the first common electrode 30211 arranged thereon. At this moment, the first common electrode 30211 and the first pixel electrode 30212 are electrified to form the electrical field. The direction of the electrical field may not be parallel to the surface of the positive-negative mixed liquid crystal layer 303, but a horizontal component of the electrical field forces may be generated, which cause the liquid crystal molecules rotate. When the first cover glass 3011 includes a plurality of first common electrodes 30211 and a plurality of first pixel electrodes 30212, a portion of the electrodes may be arranged to cover the internal surface of the first cover glass 3011. An insulation board (not shown) is arranged over the portion of the electrodes. The rest of the electrodes are arranged on the other surface of the insulation board. However, the first common electrodes 30211 and the first pixel electrodes 30212 arranged on the first cover glass 3011 are interleaved with each other. In addition, the first common electrodes 30211 and the first pixel electrodes 30212 are parallel to each other, and one first common electrode 30211 and one adjacent first pixel electrode 30212 are defined as one set. The electrical field is formed between the common electrode and the pixel electrode within each set. The power supply for each set may be independently controlled. The second common electrode 30221 and the second pixel electrode 30222 of the vertical electrode 3022 may be configured in a way similar to the above configuration of the horizontal electrode 3021.

At this moment, the electrical field formed by the common electrode and the pixel electrode of each set may be apply toward the liquid crystal molecules of the corresponding areas of the positive-negative mixed liquid crystal layer 303.

At the same time, the device may be incorporated into the liquid crystal panel made by positive-negative mixed liquid crystals. The device not only reduces the response time of the liquid crystals, but also contributes to the process of displaying and switching images. In addition, the Caton and black screen phenomenon are also reduced, which enhances the user experience.

In view of the above, two electrodes having different directions are respectively arranged on two surfaces of the liquid crystal layer. By controlling the power supply of the electrodes, the electrical fields are generated so such that the liquid crystal molecules may rotate due to the forces of the electrical fields. In this way, the rotating speed of the liquid crystal molecules are speed up, and the response time of the positive-negative mixed liquid crystals is enhanced.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A method for enhancing a response time of positive-negative mixed liquid crystals, comprising:
configuring at least one horizontal electrode, at least one vertical electrode and the positive-negative mixed liquid crystals of the liquid crystal panel;
electrifying the horizontal electrode, and the positive-negative mixed liquid crystals are in a rising time period;
electrifying the vertical electrode, and the positive-negative mixed liquid crystals are in a falling time period; and
the positive-negative mixed liquid crystals are made by adding a portion of negative liquid crystal monomers into positive liquid crystals, the response time of the positive-negative mixed liquid crystals is a sum of the rising time period and the falling time period, and during the response time, the liquid crystal panel transits from a dark state to a bright state and then back to the dark state.

2. The method as claimed in claim 1, wherein the configuring step further comprises:
arranging the horizontal electrode in a different layer at one side of the vertical electrodes, the horizontal electrodes are interleaved with the vertical electrodes, and the positive-negative mixed liquid crystals are arranged between the electrodes arranged in different layers.

3. The method as claimed in claim 1, wherein an extending direction of the horizontal electrode is vertical to the extending direction of the vertical electrode, the horizontal electrode comprises at least one first common electrode and at least one first pixel electrode parallel to the first common electrode, and the vertical electrode comprises at least one second common electrode and at least one second pixel electrode parallel to the second common electrode.

4. The method as claimed in claim 3, wherein when the horizontal electrode is electrified, the first common electrode and the first pixel electrode are electrified, and when the vertical electrode is electrified, the second common electrode and the second pixel electrode are electrified.

5. A method for enhancing a response time of positive-negative mixed liquid crystals, comprising:
configuring at least one horizontal electrode, at least one vertical electrode and the positive-negative mixed liquid crystals of the liquid crystal panel;
electrifying the horizontal electrode, and the positive-negative mixed liquid crystals are in a rising time period;
electrifying the vertical electrode, and the positive-negative mixed liquid crystals are in a falling time period; and
the positive-negative mixed liquid crystals is made by adding a portion of negative liquid crystal monomers into positive liquid crystals, and the response time of the positive-negative mixed liquid crystals is a sum of the rising time period and the falling time period.

6. The method as claimed in claim 5, wherein the configuring step comprises:
arranging the horizontal electrode in a different layer at one side of the vertical electrodes, the horizontal electrodes are interleaved with the vertical electrodes, and the positive-negative mixed liquid crystals are arranged between the electrodes arranged in different layers.

7. The method as claimed in claim 5, wherein an extending direction of the horizontal electrode is vertical to the extending direction of the vertical electrode, the horizontal electrode comprises at least one first common electrode and at least one first pixel electrode parallel to the first common electrode, the vertical electrode comprises at least one second common electrode and at least one second pixel electrode parallel to the second common electrode.

8. The method as claimed in claim 7, wherein when the horizontal electrode is electrified, the first common electrode and the first pixel electrode are electrified, and when the vertical electrode is electrified, the second common electrode and the second pixel electrode are electrified.

9. The method as claimed in claim 5, wherein the positive-negative mixed liquid crystals is made by adding a portion of negative liquid crystal monomer into the positive liquid crystals.

10. The method as claimed in claim 5, wherein during the response time, the liquid crystal panel transits from a dark state to a bright state and then back to the dark state.

11. A device for enhancing a response time of positive-negative mixed liquid crystals, comprising:
electrodes and positive-negative mixed liquid crystals; and
the electrode comprises horizontal electrodes and vertical electrodes, the positive-negative mixed liquid crystals are arranged between the horizontal electrode and the vertical electrode, the response time of the positive-negative mixed liquid crystals is a sum of a rising time period and a falling time period of the positive-negative mixed liquid crystals, the horizontal electrode is electrified during the rising time period and the vertical horizontal is electrified during the falling time period.

11. The device as claimed in claim 11, wherein the horizontal electrodes are arranged in a different layer at one side of the vertical electrodes, and the horizontal electrodes are interleaved with the vertical electrodes.

12. The device as claimed in claim 12, wherein an extending direction of the horizontal electrode is vertical to the extending direction of the vertical electrode, the horizontal electrode comprises at least one first common electrode and at least one first pixel electrode parallel to the first common electrode, the vertical electrode comprises at least one second common electrode and at least one second pixel electrode parallel to the second common electrode.

13. The device as claimed in claim 11, wherein when the horizontal electrode is electrified, the first common electrode and the first pixel electrode are electrified, and when the vertical electrode is electrified, the second common electrode and the second pixel electrode are electrified.
